(19) United States
(12) Patent Application Publication
(10) Pub. No.: US 2026/0107348 A1
(43) Pub. Date: Apr. 16, 2026

(54) SYSTEMS AND METHODS FOR REDUCING NOISE FROM QUASI-RESONANT INDUCTION CONTROL

(71) Applicant: Haier US Appliance Solutions, Inc., Wilmington, DE (US)

(72) Inventor: Steven Michael Recio, Louisville, KY (US)

(21) Appl. No.: 18/916,910

(22) Filed: Oct. 16, 2024

(51) Int. Cl. H05B 6/12; H02M 1/44; H02M 7/06; H02M 7/48; H02M 7/537; H05B 6/04

(52) U.S. Cl. CPC H05B 6/1209; H02M 1/44; H02M 7/4815; H02M 7/537; H05B 6/04; H02M 7/06

(57) ABSTRACT

An induction heating system for an induction cooking appliance is provided. The induction heating system includes a rectifier circuit configured to provide direct current (DC) power from a line voltage signal received from a power supply. The induction heating system further includes a capacitor coupled to the rectifier circuit, the capacitor configured to receive the DC power from the rectifier circuit. The induction heating system further includes a quasi-resonant (QR) inverter system connected in parallel with the capacitor, the QR inverter system comprising a QR switching device configured to supply a coil with an alternating current to inductively heat a load. The induction heating system further includes a bus switching device configured to control the DC power provided to the capacitor from the rectifier circuit. The induction heating system further includes a controller configured to control the bus switching device when the QR inverter system is in operation.

### FIELD

Example aspects of the present disclosure relate generally to induction heating systems used, for instance, in induction cooking appliances, and more particularly to reducing noise from quasi-resonant induction control in an induction cooking appliance.

### BACKGROUND

Induction cooking appliance (e.g., induction cook-tops) heat conductive cookware by magnetic induction. An induction cooking appliance applies radio frequency current to a heating coil to generate a strong radio frequency magnetic field on the heating coil. When a conductive vessel, such as a pan, is placed over the heating coil, the magnetic field coupling from the heating coil generates eddy currents on the vessel, causing the vessel to increase in temperature.

### SUMMARY

Aspects and advantages of embodiments of the present disclosure will be set forth in part in the following description, or can be learned from the description, or can be learned through practice of the embodiments.

One example aspect of the present disclosure is directed to an induction heating system for an induction cooking appliance. The induction heating system includes a rectifier circuit configured to provide direct current (DC) power from a line voltage signal received from a power supply. The induction heating system further includes a capacitor coupled to the rectifier circuit, the capacitor configured to receive the DC power from the rectifier circuit. The induction heating system further includes a quasi-resonant (QR) inverter system connected in parallel with the capacitor, the QR inverter system comprising a QR switching device configured to supply a coil with an alternating current to inductively heat a load. The induction heating system further includes a bus switching device configured to control the DC power provided to the capacitor from the rectifier circuit. The induction heating system further includes a controller configured to control the bus switching device when the QR inverter system is in operation.

Another example aspect of the present disclosure is directed to a method for controlling a quasi-resonant (QR) inverter system. The method includes providing, by a bus switching device, direct current (DC) power to a capacitor at a start-up time of the QR inverter system. The method further includes providing, by a QR switching device of the QR inverter system, an alternating current to a coil to inductively heat a load at the start-up time. The QR inverter system is connected in parallel with the capacitor, the capacitor configured to receive the DC power from a rectifier circuit coupled to the capacitor.

Another example aspect of the present disclosure is directed to an induction cooking appliance. The induction cooking appliance includes a user interface. The induction cooking appliance includes a controller. The induction cooking appliance includes an induction heating system. The induction heating system includes a rectifier circuit configured to provide direct current (DC) power from a line voltage signal received from a power supply. The induction heating system further includes a capacitor coupled to the rectifier circuit, the capacitor configured to receive the DC power from the rectifier circuit. The induction heating system further includes a quasi-resonant (QR) inverter system connected in parallel with the capacitor, the QR inverter system comprising a QR switching device configured to supply a coil with an alternating current to inductively heat a load. The induction heating system further includes a bus switching device configured to control the DC power provided to the capacitor from the rectifier circuit. The controller is configured to control the bus switching device when the QR inverter system is in operation.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an example induction cooking appliance according to example embodiments of the present disclosure;

FIG. 2 provides a block diagram of an example induction heating system according to example embodiments of the present disclosure;

FIG. 3 depicts a schematic implementation of an example induction heating system according to example embodiments of the present disclosure;

FIG. 4 provides a graphical representation of example signals of an induction heating system according to example embodiments of the present disclosure; and

FIG. 5 provides an example method for controlling a quasi-resonant (QR) inverter system according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to noise reduction in induction heating systems having a quasi-resonant (QR) inverter system. In general, QR induction controls may face difficulties when providing lower wattage continuous power. Accordingly, QR induction controls may include duty cycling to achieve a desired power when at a lower power setting. When the QR induction control starts (e.g., switching device of a QR inverter system begins switching), an inrush current may be applied to a resonant capacitor of the QR inverter system. Specifically, the inrush current may be supplied by a DC bus capacitor that may be directly coupled to the resonant capacitor. This inrush current may cause an undesirable audible ticking noise that may be a nuisance to a user of the induction heating system (e.g., induction cooking appliance). In addition, the inrush current may damage components of the QR induction heating system, such as the resonant capacitor.

As such, example aspects of the present disclosure provide systems and methods for reducing this inrush current and the associated audible noise. For instance, a bus switching device may be configured to control the DC power provided to the DC bus capacitor. As such, the bus switching device may remove the DC bus capacitor from the circuit synchronous with turning off the switching device of the QR inverter system (e.g., QR switching device) at a zero-cross time of the line voltage. The next time the QR switching device is started, such as at a start-up time, the bus switching device may provide power to the DC bus capacitor. This may result in reduced inrush current as the DC bus capacitor may be at least partially discharged.

Example aspects of the present disclosure provide multiple technical effects and benefits. For example, systems and methods provided herein may reduce inrush current applied to a QR inverter system, reducing the audible noise made by the induction heating system while in, for example, a low power mode. In addition, reducing this inrush current may prevent damage to components of the induction heating system, such as the resonant capacitor.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

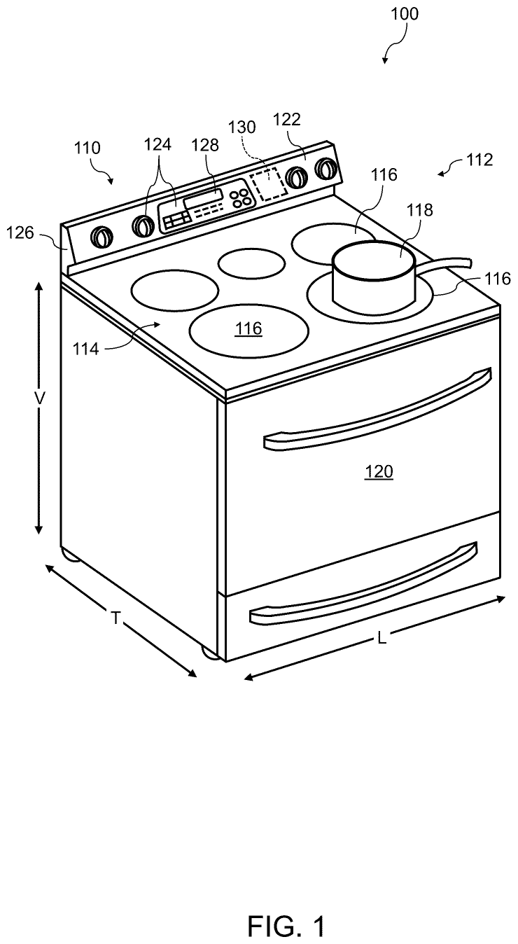

FIG. 1 depicts a perspective view of an induction cooking appliance 100. The induction cooking appliance 100 may include a cooktop 112, such as an induction cooktop. Induction cooking appliance 100 is provided by way of example only and is not intended to limit the present subject matter to the arrangement shown in FIG. 1. Thus, the present subject matter may be used with other induction cooking appliances such as oven appliances, single oven range appliances, double oven range appliances, standalone cooktop appliances, cooktop appliances without an oven, etc.

Induction cooking appliance 100 generally defines a vertical direction V, a lateral direction L, and a transverse direction T, each of which is mutually perpendicular, such that an orthogonal coordinate system is generally defined. A cooking surface 114 of cooktop 112 includes one or more induction heating elements 116. As shown in FIG. 1, cooktop 112 may include a plurality of heating elements 116. The heating elements 116 are generally positioned at, e.g., on or proximate to, the cooking surface 114. For the embodiment depicted, the cooktop 112 includes five heating elements 116 spaced along cooking surface 114. However, in other embodiments, the cooktop 112 may include any other suitable shape, configuration, and/or number of heating elements 116. Each of the heating elements 116 may be induction heating elements 116 including induction coils, or cooktop 112 may include a combination of different types of heating elements 116. For example, in various embodiments, the cooktop 112 may include any other suitable type of heating elements 116 in addition to the induction heating element, such as a resistive heating element or gas burners, etc.

As shown in FIG. 1, a load 118 (e.g., cooking vessel), such as a pot, pan, or the like, may be placed on an induction heating element 116 to heat the load 118 and cook or heat food items placed in load 118. Induction cooking appliance 100 may also include a door 120 that permits access to a cooking chamber (not shown) of induction cooking appliance 100, e.g., for cooking or baking of food items therein. A user interface 122 (e.g., control panel) having user input devices 124 (e.g., user input devices) may permit a user to make selections for cooking of food items. Although shown on a backsplash or back panel 126 of induction cooking appliance 100, user interface 122 may be positioned in any suitable location. User input devices 124 may include buttons, knobs, and the like, as well as combinations thereof, and/or user input devices 124 may be implemented on a remote user interface device such as a smartphone, tablet, etc. As an example, a user may manipulate one or more user input devices 124 to select a temperature and/or a heat or power output for each heating element 116. The selected temperature or heat output of heating element 116 affects the heat transferred to load 118 placed on heating element 116. The user interface 122 may also include a display 128.

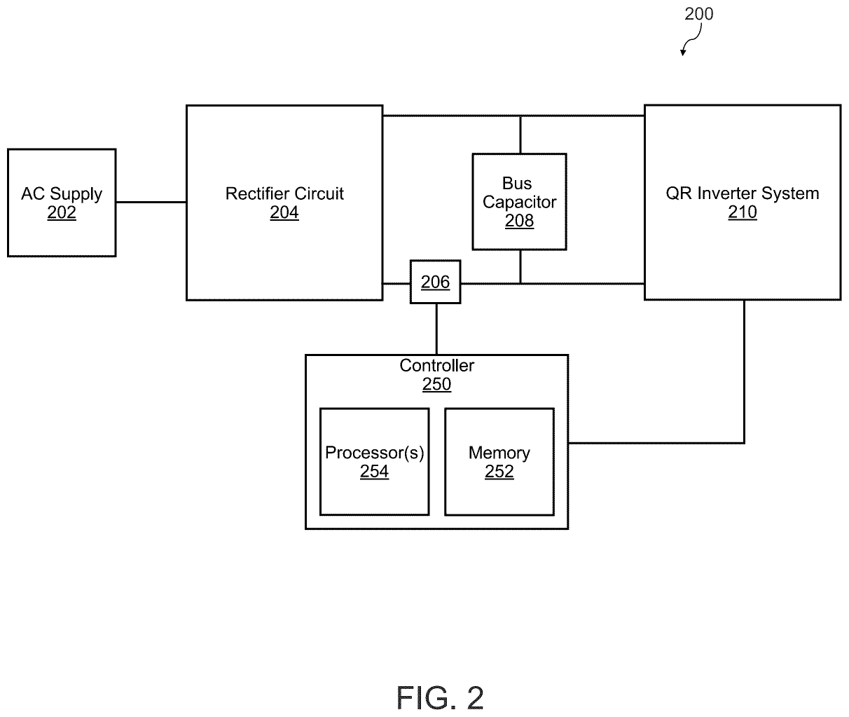

The induction cooking appliance 100 may include a control system 130 for controlling one or more of the plurality of heating elements 116. Specifically, the control system 130 may include a controller operably coupled to the user interface 122 (e.g., user input devices 124 and/or display 128). Control system 130 may be operably coupled to each of the plurality of heating elements 116 for controlling a heating level of each of the plurality of heating elements 116 in response to one or more user inputs received through the user interface 122 and user input devices 124. The control system 130 may also provide output to the display 128, such as an indication of a selected power level, which heating element(s) 116 is or are activated, etc. Furthermore, as will be discussed in greater detail below, the control system 130 may include one or more controllers configured to control operation of an induction heating system such as induction heating system 200 (FIG. 2).

FIG. 2 provides a block diagram depicting an induction heating system 200 according to example embodiments of the present disclosure. While induction heating system 200 is discussed with reference to induction cooking appliance 100 of FIG. 1, those of ordinary skill in the art will understand that induction heating system 200 may be used in any suitable cooking system and/or appliance without deviating from the scope of the present disclosure.

Induction heating system 200 generally includes a rectifier circuit 204. Rectifier circuit 204 may receive a line voltage signal (e.g., alternating current (AC) power) from an AC power supply 202, which may provide conventional 60 Hz 120 or 240 volt AC supplied by utility companies. Specifically, rectifier circuit 204 may rectify the line voltage signal from the AC power supply 202 to provide direct current (DC) power (e.g., rectified power). In some embodiments, rectifier circuit 204 may include additional circuitry, such as signal filtering and power factor correction circuitry to filter the DC power. In some embodiments, AC power supply 202 and/or rectifier circuit 204 is configured to provide power to multiple induction coils.

Induction heating system 200 further includes a capacitor 208 (e.g., DC bus capacitor). As shown, capacitor 208 is coupled to rectifier circuit 204 and configured to receive DC power from rectifier circuit 204. In some embodiments, DC bus capacitor 208 may have a capacitance that is less than 10 microfarads (μF), such as about 3 μF. Induction heating system 200 further includes a bus switching device 206. As shown in FIG. 2, bus switching device 206 may be configured to control the DC power provided to the bus capacitor 208 from, for example, the rectifier circuit 204. For instance, bus switching device 206 may switch (e.g., disconnect) the bus capacitor 208 from the rectifier circuit 204 such that the bus capacitor 208 is effectively removed from the circuit.

Induction heating system 200 further includes an inverter system 210 coupled to capacitor 208. Specifically, inverter system 210 may be coupled to capacitor 208 in, for example, a parallel configuration. As shown, inverter system 210 may be a quasi-resonant (QR) inverter system. Specifically, inverter system 210 includes a QR switching device configured to supply a coil with an alternating current to inductively heat a load, such as load 118 depicted in FIG. 1. The QR switching device may energize the coil beginning at a start-up time of the inverter system 210. Specifically, the QR switching device may energize the coil by switching between an open state and a closed state beginning at the start-up time to supply the alternating current to the coil.

In some embodiments, the induction coil of the QR inverter system 210 may be defined as an induction heating element, such as induction heating element 116 as shown in FIG. 1. The induction coil, when supplied with alternating current, may inductively heat a load (e.g., pan, cooking vessel) or other object placed on, over, or near the coil. It will be understood that use of the term “load” herein is used merely as an example, and that term will generally include any object of a suitable type that is capable of being heated by an induction heating coil.

Induction heating system 200 further includes controller 250. In some embodiments, controller 250 may be implemented into a control system of an induction cooking appliance, such as into control system 130 of induction cooking appliance 100 depicted in FIG. 1.

Controller 250 may be operable coupled to the QR switching device 215 of QR inverter system 210. Specifically, the switching frequency of the alternating current supplied to the induction coil 220 by QR switching device 215 may be controlled by controller 250. For example, controller 250 may control QR switching device 215 to supply coil 220 with alternating current beginning at a start-up time.

Controller 250 is further configured to control bus switching device 206 when the QR inverter system 210 is in operation (e.g., an operating mode). For instance, QR inverter system 210 may be in operation when a coil of the QR inverter system 210 is energized to inductively heat a load. In some embodiments, controller 250 may be configured to control bus switching device 206 on a first start up of the QR inverter system 210.

In some embodiments, controller 250 may control the bus switching device 206 when the QR inverter system 210 is in a low power mode. For example, the QR inverter system 210 may provide lower wattage continuous power during the low power mode by, for example, duty cycling. During the low power mode, controller 250 may control (e.g., open/close) the bus switching device 206 synchronous with controlling the QR switching device 215 of inverter system 210.

In some embodiments, controller 250 is configured to control the bus switching device 206 to provide the DC power to the capacitor 208 at a start-up time of the QR inverter system 210. For example, the start-up time of the QR inverter system 210 may be defined as when the QR switching device 215 begins supplying the alternating current to the coil 220. In addition, controller 250 may control the QR switching device 215 to provide the alternating current to the coil 220 at the start-up time. In some embodiments, the start-up time may correspond to a zero-cross time of the line voltage signal.

For example, controller 250 may control bus switching device 206 to remove the bus capacitor 208 from the circuit synchronous with turning off the QR switching device 215 of the QR inverter system 210 at, for example, a zero-cross time of the line voltage signal. The next time the QR switching device 215 is started, such as at the start-up time, the bus switching device 206 may be controlled (e.g., by controller 250) to provide power to the bus capacitor 208. Removing the bus capacitor 208 from the circuit at the zero-cross time may allow for the bus capacitor 208 to be at least partially discharged at the start-up time.

Controller 250 may include memory 252 and one or more processors 254 such as microprocessors, CPUs or the like, such as general or special purpose microprocessors operable to execute programming instructions or micro-control code associated with operation of induction cooking appliance 100. Memory 252 may represent random access memory such as DRAM, or read only memory such as ROM or FLASH. In one embodiment, the processor 254 executes programming instructions stored in memory 252. Memory 252 may be a separate component from controller 250 or may be included onboard controller 250.

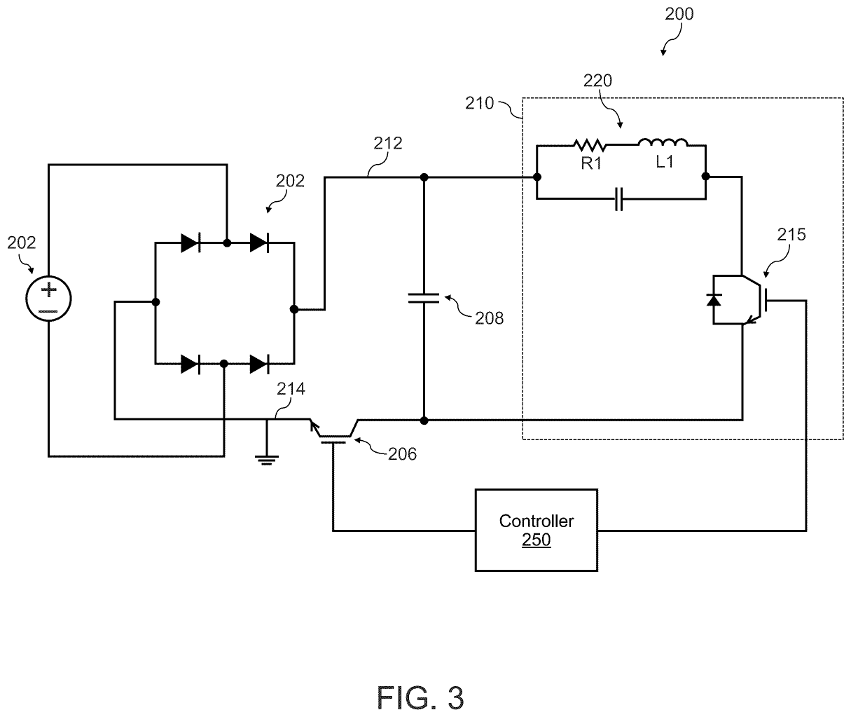

Referring now to FIG. 3, a circuit schematic depicting induction heating system 200 according to example embodiments of the present disclosure is provided. As shown, induction heating system 200 may include an AC power supply 202 operatively coupled to a rectifier circuit 204. As shown in FIG. 3, rectifier circuit 204 may be a full wave rectifier that includes four diodes. Rectifier circuit 204 may provide DC power from a line voltage signal received from AC power supply 202. DC bus capacitor 208 may receive the DC power from rectifier circuit 204. As shown, the bus capacitor 208 may be coupled to the rectifier circuit 204 in a parallel configuration.

As shown in FIG. 3, the QR inverter system 210 may be coupled to the bus capacitor 208 in a parallel configuration. The QR inverter system 210 may include coil 220 and resonant capacitor 222 that form a resonance tank. Induction coil 220 and, if present, load 118 (shown in FIG. 1) may be represented (e.g., modeled) in FIG. 3 as an inductor L1 (e.g., coil 220) and a resistor R1 (e.g., load 118). QR inverter system 210 further includes QR switching device 215 coupled to the resonant tank (e.g., coil 220 and resonant capacitor 222). As previously described, QR switching device 215 may supply coil 220 with an alternating current at a desired frequency set by, for example, controller 250. Accordingly, controller 250 may be operatively coupled to QR switching device 215.

Controller 250 may also be operatively coupled to the bus switching device 206. As previously described, bus switching device 206 may be configured to control the DC power supplied to capacitor 208 by, for example, removing capacitor 208 from the rectifier circuit 204. For example, bus switching device 206 may be switched to an open state such that DC power is withheld from capacitor 208 prior to the start-up time of the QR inverter system 210. In addition, QR switching device 215 may withhold the alternating current to the coil prior to the start-up time, such as from a shut down time of QR inverter system 210 until the start-up time. In some embodiments, bus switching device 206 may remove the bus capacitor 208 from the circuit at the shut down time of the QR inverter system 210, such that the bus capacitor 208 is at least partially discharged at the start-up time when coil 220 is energized. The discharged bus capacitor 208 may prevent a current inrush to the QR inverter system 210 at the start-up time. For example, if the bus capacitor 208 is fully charged at the start-up time, an inrush of current may be applied to resonant capacitor 222 which may be discharged. This may cause an audible noise that may be a nuisance to a user.

As shown in FIG. 3, bus capacitor 208 and inverter system 210 may be operatively coupled to rectifier 204 by a high-side path 212 and a low-side path 214. In some embodiments, high-side path 212 may be defined by a bus voltage, which is supplied to bus capacitor 208 by rectifier 204. Low-side path 214 may be defined by a ground supplied to low-side path 214. As shown, bus switching device 206 may be positioned between bus capacitor 208 and rectifier 204, such as along low-side path 214. Bus switching device 206 may be configured to withstand high voltages associated with low-side path 214. Accordingly, bus switching device 206 may be an insulated-gate bipolar transistor (IGBT).

In some embodiments, the shut down time may correspond to a zero-cross time of the line voltage signal. For example, the QR switching component 215 may stop energizing coil 220 at the zero-cross time of the line voltage signal. In addition, the bus switching component 206 may remove the bus capacitor 208 from the rectifier circuit 204 at the zero-cross time of the line voltage signal, such that bus capacitor 208 is at least partially discharged at the start-up time.

In some embodiments, both the QR switching device 215 and the bus switching device 206 may be insulated-gate bipolar transistors (IGBTs). However, other suitable switching devices (e.g., MOSFETs) may be used without deviating from the scope of the present disclosure.

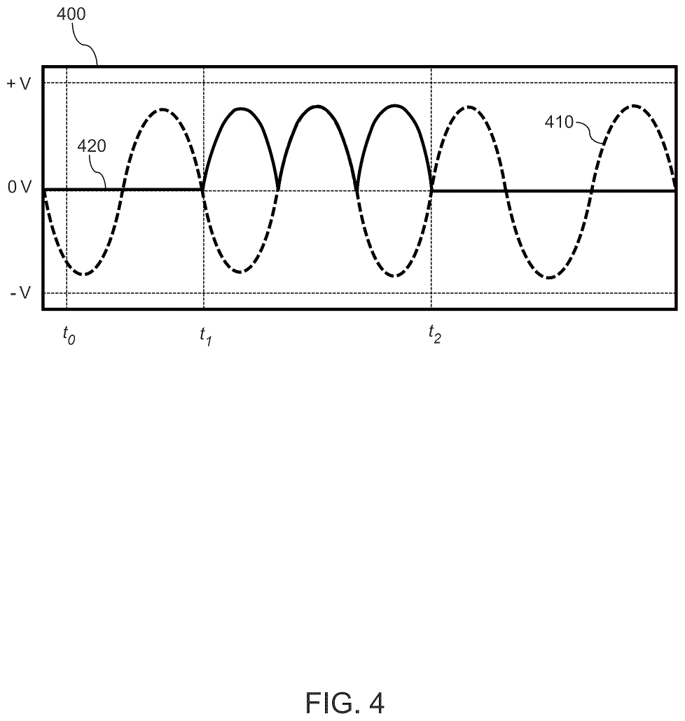

FIG. 4 provides a graphical representation of example signals of an induction heating system according to example embodiments of the present disclosure. Specifically, plot 400 of FIG. 4 is described with reference to induction heating system 200 as described with reference to FIGS. 2-3. Plot 400 depicts an example line voltage signal 410 over a time period and an example bus voltage 420 indicating the voltage across bus capacitor 208 over the same time period.

As previously described, bus switching device 206 may provide a DC power signal to the bus capacitor 208 at a start-up time (t₁) of QR inverter system 210. As shown in plot 400, the voltage across the bus capacitor 208 may increase from start-up time (t₁) until the bus capacitor is fully charged. Specifically, the voltage across bus capacitor 208 may correspond to (e.g., follow) the full-wave rectified line voltage supplied by rectifier circuit 204. For instance, the capacitance associated with the bus capacitor 208 may not be large enough to hold the DC bus at a constant value. As such, the bus voltage 420 may oscillate based on the line voltage signal 410. In addition, QR switching device 215 of QR inverter system 210 may provide an alternating current to the coil 220 beginning at start-up time (t₁). Specifically, bus switching device 206 may withhold the DC power from the bus capacitor 208 prior to the start-up time (e.g., at t₀), such that capacitor 208 is at least partially discharged at the start-up time (t₁).

As shown in FIG. 4, the start-up time (t₁) of QR inverter system 210 may correspond to the zero-cross time of the line voltage signal 410. Specifically, line voltage signal 410 may switch from a first current polarity to a second current polarity at the zero-cross time (t₁). In addition, the DC power signal may be provided to bus capacitor 208 at the zero-cross time of line voltage signal 410.

Power may be provided to the bus capacitor 208 from the start-up time (t₁) until the shut-down time (t₂). The shut-down time (t₂) may indicate a time when operation of the QR inverter system 210 has ceased, such as when the coil is no longer energized. At the shut-down time (t₂), controller 250 may control the bus switching device 206 to withhold power to the bus capacitor 208 by switching the bus switching device 206 to an open state. Accordingly, bus capacitor 208 may be at least partially discharged for future operation of the QR inverter system 210. As shown, the shut-down time (t₂) may correspond to a zero-cross time of line voltage signal 410.

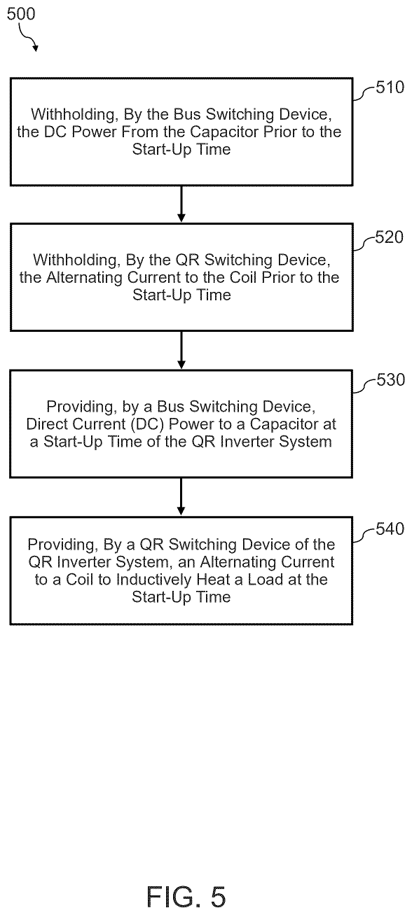

Referring now to FIG. 5, an example method 500 for controlling a quasi-resonant (QR) inverter system is provided. While method 500 is generally discussed with reference to QR inverter system 210 of induction heating system 200 as shown in FIGS. 2-3, those of ordinary skill in the art will understand that method 500 may be implemented in any applicable induction heating system and/or induction cooking appliance for controlling a quasi-resonant inverter system. Method 500 provides a series of steps performed in a particular order for purposes of illustration and discussion. Those of ordinary skill in the art, using the disclosures provided herein, will understand that any step of method 500 discussed herein can be adapted, rearranged, expanded, omitted, or modified in various ways without deviating from the scope of the present disclosure.

In some embodiments, method 500 may include, at (510), withholding, by the bus switching device, the DC power from the capacitor prior to the start-up time. For instance, bus switching device 206 may withhold the DC power from the bus capacitor 208 prior to the start-up time.

In some embodiments, method 500 may include, at (520), withholding, by the QR switching device, the alternating current to the coil prior to the start-up time. For instance, the QR switching device 215 may withhold the alternating current to the coil 220 prior to the start-up time.

At (530), method 500 includes providing, by a bus switching device, direct current (DC) power to a capacitor at a start-up time of the QR inverter system. For instance, bus switching device 206 may provide DC power to bus capacitor 208 at a start-up time of the QR inverter system 210.

At (540), method 500 includes providing, by a QR switching device of the QR inverter system, an alternating current to a coil to inductively heat a load at the start-up time. For instance, QR switching device 215 of QR inverter system 210 may provide an alternating current to coil 220 at the start-up time of the QR inverter system 210. The QR inverter system is connected in parallel with bus capacitor 208 configured to receive the DC power from rectifier circuit 204 coupled to the bus capacitor 208.

One example aspect of the present disclosure is directed to an induction heating system for an induction cooking appliance. The induction heating system includes a rectifier circuit configured to provide direct current (DC) power from a line voltage signal received from a power supply. The induction heating system further includes a capacitor coupled to the rectifier circuit, the capacitor configured to receive the DC power from the rectifier circuit. The induction heating system further includes a quasi-resonant (QR) inverter system connected in parallel with the capacitor, the QR inverter system comprising a QR switching device configured to supply a coil with an alternating current to inductively heat a load. The induction heating system further includes a bus switching device configured to control the DC power provided to the capacitor from the rectifier circuit. The induction heating system further includes a controller configured to control the bus switching device when the QR inverter system is in operation.

In some examples, the controller is configured to control the bus switching device to provide the DC power to the capacitor at a start-up time of the QR inverter system.

In some examples, controller is further configured to control the QR switching device to provide the alternating current to the coil at the start-up time.

In some examples, the start-up time corresponds to a zero-cross time of the line voltage signal.

In some examples, the controller is further configured to control the bus switching device to withhold the DC power from the capacitor prior to the start-up time.

In some examples, the controller is further configured to control the QR switching device to withhold the alternating current to the coil prior to the start-up time.

In some examples, the capacitor is at least partially discharged at the start-up time.

In some examples, the QR switching device and the bus switching device are insulated-gate bipolar transistors (IGBTs).

Another example aspect of the present disclosure is directed to a method for controlling a quasi-resonant (QR) inverter system. The method includes providing, by a bus switching device, direct current (DC) power to a capacitor at a start-up time of the QR inverter system. The method further includes providing, by a QR switching device of the QR inverter system, an alternating current to a coil to inductively heat a load at the start-up time. The QR inverter system is connected in parallel with the capacitor, the capacitor configured to receive the DC power from a rectifier circuit coupled to the capacitor.

In some examples, the start-up time corresponds to a zero-cross time of a line voltage signal provided to the rectifier circuit from a power supply.

In some examples, the method further includes withholding, by the bus switching device, the DC power from the capacitor prior to the start-up time.

In some examples, the method further includes withholding, by the QR switching device, the alternating current to the coil prior to the start-up time.

In some examples, the capacitor is at least partially discharged at the start-up time.

In some examples, the QR switching device and the bus switching device are insulated-gate bipolar transistors (IGBTs).

Another example aspect of the present disclosure is directed to an induction cooking appliance. The induction cooking appliance includes a user interface. The induction cooking appliance includes a controller. The induction cooking appliance includes an induction heating system. The induction heating system includes a rectifier circuit configured to provide direct current (DC) power from a line voltage signal received from a power supply. The induction heating system further includes a capacitor coupled to the rectifier circuit, the capacitor configured to receive the DC power from the rectifier circuit. The induction heating system further includes a quasi-resonant (QR) inverter system connected in parallel with the capacitor, the QR inverter system comprising a QR switching device configured to supply a coil with an alternating current to inductively heat a load. The induction heating system further includes a bus switching device configured to control the DC power provided to the capacitor from the rectifier circuit. The controller is configured to control the bus switching device when the QR inverter system is in operation.

In some examples, the controller is configured to control the bus switching device to provide the DC power to the capacitor at a start-up time of the QR inverter system.

In some examples, controller is further configured to control the QR switching device to provide the alternating current to the coil at the start-up time.

In some examples, the start-up time corresponds to a zero-cross time of the line voltage signal.

In some examples, the capacitor is at least partially discharged at the start-up time.

In some examples, the QR switching device and the bus switching device are insulated-gate bipolar transistors (IGBTs).

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An induction heating system for an induction cooking appliance, the induction heating system comprising:
a rectifier circuit configured to provide direct current (DC) power from a line voltage signal received from a power supply;
a capacitor coupled to the rectifier circuit, the capacitor configured to receive the DC power from the rectifier circuit;
a quasi-resonant (QR) inverter system connected in parallel with the capacitor, the QR inverter system comprising a QR switching device configured to supply a coil with an alternating current to inductively heat a load;
a bus switching device configured to control the DC power provided to the capacitor from the rectifier circuit; and
a controller configured to control the bus switching device when the QR inverter system is in operation.

2. The induction heating system of claim 1, wherein the controller is configured to control the bus switching device to provide the DC power to the capacitor at a start-up time of the QR inverter system.

3. The induction heating system of claim 2, wherein controller is further configured to control the QR switching device to provide the alternating current to the coil at the start-up time.

4. The induction heating system of claim 3, wherein the start-up time corresponds to a zero-cross time of the line voltage signal.

5. The induction heating system of claim 2, wherein the controller is further configured to control the bus switching device to withhold the DC power from the capacitor prior to the start-up time.

6. The induction heating system of claim 5, wherein the controller is further configured to control the QR switching device to withhold the alternating current to the coil prior to the start-up time.

7. The induction heating system of claim 2, wherein the capacitor is at least partially discharged at the start-up time.

8. The induction heating system of claim 1, wherein the QR switching device and the bus switching device are insulated-gate bipolar transistors (IGBTs).

9. A method for controlling a quasi-resonant (QR) inverter system, the method comprising:
providing, by a bus switching device, direct current (DC) power to a capacitor at a start-up time of the QR inverter system; and
providing, by a QR switching device of the QR inverter system, an alternating current to a coil to inductively heat a load at the start-up time,
wherein the QR inverter system is connected in parallel with the capacitor, the capacitor configured to receive the DC power from a rectifier circuit coupled to the capacitor.

10. The method of claim 9, wherein the start-up time corresponds to a zero-cross time of a line voltage signal provided to the rectifier circuit from a power supply.

11. The method of claim 9, further comprising:
withholding, by the bus switching device, the DC power from the capacitor prior to the start-up time.

12. The method of claim 11, further comprising:
withholding, by the QR switching device, the alternating current to the coil prior to the start-up time.

13. The method of claim 9, wherein the capacitor is at least partially discharged at the start-up time.

14. The method of claim 9, wherein the QR switching device and the bus switching device are insulated-gate bipolar transistors (IGBTs).

15. An induction cooking appliance, comprising: ′
a user interface;
a controller; and
an induction heating system, comprising:
a rectifier circuit configured to provide direct current (DC) power from a line voltage signal received from a power supply;
a capacitor coupled to the rectifier circuit, the capacitor configured to receive the DC power from the rectifier circuit;
a quasi-resonant (QR) inverter system connected in parallel with the capacitor, the QR inverter system comprising a QR switching device configured to supply a coil with an alternating current to inductively heat a load; and
a bus switching device configured to control the DC power provided to the capacitor from the rectifier circuit,
wherein the controller is configured to control the bus switching device when the QR inverter system is in operation.

16. The induction cooking appliance of claim 15, wherein the controller is configured to control the bus switching device to provide the DC power to the capacitor at a start-up time of the QR inverter system.

17. The induction cooking appliance of claim 16, wherein controller is further configured to control the QR switching device to provide the alternating current to the coil at the start-up time.

18. The induction cooking appliance of claim 17, wherein the start-up time corresponds to a zero-cross time of the line voltage signal.

19. The induction cooking appliance of claim 16, wherein the capacitor is at least partially discharged at the start-up time.

20. The induction cooking appliance of claim 15, wherein the QR switching device and the bus switching device are insulated-gate bipolar transistors (IGBTs).
